(19) United States
(12) Patent Application Publication
(10) Pub. No.: US 2017/0297390 A1
(43) Pub. Date: Oct. 19, 2017

(54) Self-Latching Trailer Hitch Device

(71) Applicant: Quick Pin LLC, South Whitley, MI (US)

(72) Inventor: Aaron McDevitt, South Whitley, IN (US)

(21) Appl. No.: 15/488,106

(22) Filed: Apr. 14, 2017

Related U.S. Application Data
(60) Provisional application No. 62/322,943, filed on Apr. 15, 2016.

(51) Int. Cl. B60D 1/06; B60D 1/60

(52) U.S. Cl. CPC B60D 1/065; B60D 1/60

(57) ABSTRACT

A self-latching hitch device comprising a bracket that fits around a hitch receiver, a housing containing a pull pin, and a biasing member urging the pin to a closed position when the pin of the device aligns with the pull pin holes in the hitch receiver and the pull pin holes in a ball mount shaft, such that the device can be placed on a hitch receiver when the receiver holes and ball mount shaft holes are not in alignment, the ball mount shaft can be moved longitudinally with respect to the hitch receiver, and the device pin will lock the ball mount shaft into position with respect to the hitch receiver when the holes of the ball mount shaft and hitch receiver come into alignment.

### CROSS-REFERENCES TO RELATED APPLICATIONS

This Application claims priority to and incorporates fully by reference U.S. Provisional Application No. 62/322,943, Self-Latching Trailer Hitch Device, filed on Apr. 15, 2016.

### STATEMENT REGARDING FEDERALLY SPONSORED RESEARCH OR DEVELOPMENT

Not applicable.

### BACKGROUND

The present invention relates to a self-latching hitch device for use with trucks, trailers, and tractors outfitted with receiver-style hitches. Receiver-style hitches are also commonly referred to as box hitches, tube hitches, or Reese hitches. The present invention is useable in relation to and connection with a number of readily commercially available receiver-style hitch systems. The self-latching trailer hitch device of the present invention enables a user to more easily align a vehicle to be hitched to a hitch frame of a towing vehicle.

Common receiver-style hitches comprise mounting flanges connected to each other by a perpendicular transfer beam, and a hitch receiver extending transversely from the transfer beam. The hitch receiver is typically a square-shaped hollow member with openings of varying width, depending on the amount of weight intended to be borne and pulled by the hitch assembly. Common widths include 1¼ inches, 2 inches, and 2½ inches. The hitch receiver can mate with an appropriately sized shaft, which shaft can be attached to a broad variety of commonly used towing connectors. The shaft is configured to mate within the hitch receiver. The shaft is typically shaped and sized correspondingly to the hitch receiver, and is commonly a square member between 1¼ inches and 2½ inches wide. The shaft also typically includes one or more transverse holes through its sides. These holes are sized and spaced to align with corresponding holes in the sides of the hitch receiver. When these holes are aligned, a pull pin can be placed through the hitch receiver and through the corresponding holes in the shaft, securing a ball mount in place. The pull pin may itself be secured with a cotter pin or spring pin. A ball installed on the ball mount may be a variety of sizes in diameter, so as to mate with a variety of sizes of trailer couplers. In most commonly-available receiver-style hitches, the ball can be changed, so that different diameters of ball may be used in connection with the same ball mount. The most common towing connector attached to the shaft is a ball mount. Although the embodiments discussed herein will be exemplified with respect to a ball mount, it should be understood that the present invention can be used in connection with any hitch receiver configured to receive a shaft.

Pull pins come in a variety of lengths and diameters to support different amounts of load and different sizes and classes of receiver-style hitch. Pull pins are commonly provided in a variety of diameters and lengths. Typical diameters include, by way of example, 9/32 inch, ½ inch, ⅝ inch, and ¾ inch, and typical lengths include, by way of example, 2, 3, 4, 5, 6, and 7 inches.

Receiver-style hitches are generally categorized into four classes, each of which are rated for a different maximum tongue weight and a maximum gross trailer weight. Class I hitches are generally rated for a tongue weight of up to 200 pounds and a gross towing weight of up to 2,000 pounds. Class II hitches are generally rated for a tongue weight of up to 300 pounds, and a gross towing weight of up to 3,500 pounds. Class III hitches are generally rated for a tongue weight of up to 500 pounds, and a gross towing weight of up to 5,000 pounds. Class IV hitches are generally rated for a tongue weight of up to 1,000 pounds, and a gross towing weight of up to 10,000 pounds.

Receiver-style hitches are commonly used in the following manner: a trailer to be towed has a tongue jack attached to its tongue and used to raise or lower the coupler. The tongue jack is used to raise the coupler to a height sufficient to clear the top of the ball. The ball mount, with an appropriately-sized ball installed, is mated to the hitch receiver and locked in place with a pull pin. The tow vehicle is then backed carefully towards the trailer until the ball, which is commonly of a diameter of 2½ inches or less, is located directly under the coupler. If the ball and the coupler are misaligned laterally or longitudinally, adjustments will have to be made by either moving the vehicle to put the ball into position, or by manually moving the trailer to place the coupler into alignment over the ball. Both types of adjustment can be difficult to make with sufficient precision to align the coupler directly over the ball. After the ball and coupler are aligned, the tongue jack is used to lower the opened coupler onto the ball. After the ball is firmly seated within the coupler, the coupler is latched into a closed position and locked. At this time, supplemental or safety equipment such as weight distribution spring bars, safety chains, or electrical connections may be connected. As will be apparent to one skilled in the art, one of the major challenges to using a receiver-style hitch system is the inconvenience of obtaining sufficiently precise alignment of the ball and the coupler.

### SUMMARY

The present invention teaches a self-latching hitch device that largely replaces prior art pull pins within a receiver-style hitch system. Embodiments of the present invention comprise a bracket that fits around a hitch receiver. The bracket comprises a housing containing a pull pin and a biasing member urging the pull pin toward a closed position. In use, the self-latching hitch device of the present invention can be placed on a hitch receiver within which a ball mount shaft has been placed, but holes in the hitch receiver and corresponding holes in the ball mount shaft are not in alignment. The pin within the device is biased through one hole of the hitch receiver by the biasing member, but is stopped by a solid portion of a wall of the ball mount shaft. The ball mount shaft can be moved longitudinally within the receiver until the holes of the mount shaft slide into alignment with the corresponding holes of the hitch receiver, at which point the biasing member will force the pin through the remaining holes and lock the shaft in place.

Embodiments of the present invention allow a trailer to be attached to a tow vehicle with a receiver-style hitch system in a manner that facilitates more convenient alignment of the tow vehicle with the trailer to be towed. Embodiments of the present invention may, by way of example, be used in the following manner: a trailer to be towed has a tongue jack attached to its tongue and coupler that is used to raise or lower the coupler. The tongue jack is used to raise the coupler to a height sufficient to clear the top of the ball. The ball mount shaft, with an appropriately-sized ball installed, is mated to the hitch receiver but not locked in place with a pull pin. The self-latching device of the present invention is placed around the hitch receiver such that the pin of the present device pushes through one locking hole in the hitch receiver wall but is stopped from further progress by a solid portion of a shaft wall. The tow vehicle is then backed carefully toward trailer until the ball is located in the vicinity of the coupler. The ball may then be moved to the coupler by a combination of making small adjustments to the location of the coupler and moving the ball mount shaft longitudinally in and out within the hitch receiver. After the ball and coupler are aligned, the tongue jack is used to lower the opened coupler onto the ball. After the ball is firmly seated within the coupler, the coupler is latched into a closed position and locked closed. The tow vehicle can then be moved forward or backward to align the locking holes of the ball mount shaft with the locking holes of the hitch receiver. At the moment of alignment, the biasing member will rapidly force the pin through all of the locking holes, locking the ball mount shaft to the hitch receiver with substantially similar or greater structural integrity than a traditional pull pin. At this time, supplemental or safety equipment such as weight distribution spring bars, safety chains, or electrical connections may be connected.

Embodiments of the present invention may use pins of virtually any length or diameter, and include lengths and diameters commonly used for commercial receiver-style hitches. Embodiments of the present invention may be sized and configured for use in connection with Class I, Class II, Class III, or Class IV receiver-style hitch systems. These and other objects of the present invention will become readily apparent upon further review of the following specification and drawings.

### BRIEF DESCRIPTION OF THE DRAWINGS

FIG. 1 is a perspective view of one embodiment of the device of the present invention.

FIG. 2 is an exploded view of the housing and pin assembly of one embodiment of the device of the present invention.

FIG. 3 is a perspective view of a towing vehicle equipped with one embodiment of the device of the present invention, with said device securing a ball mount shaft to a hitch receiver.

FIG. 4 is a perspective view of one embodiment of the device of the present invention in a closed position.

FIG. 5 is a perspective view of one embodiment of the device of the present invention in an open position.

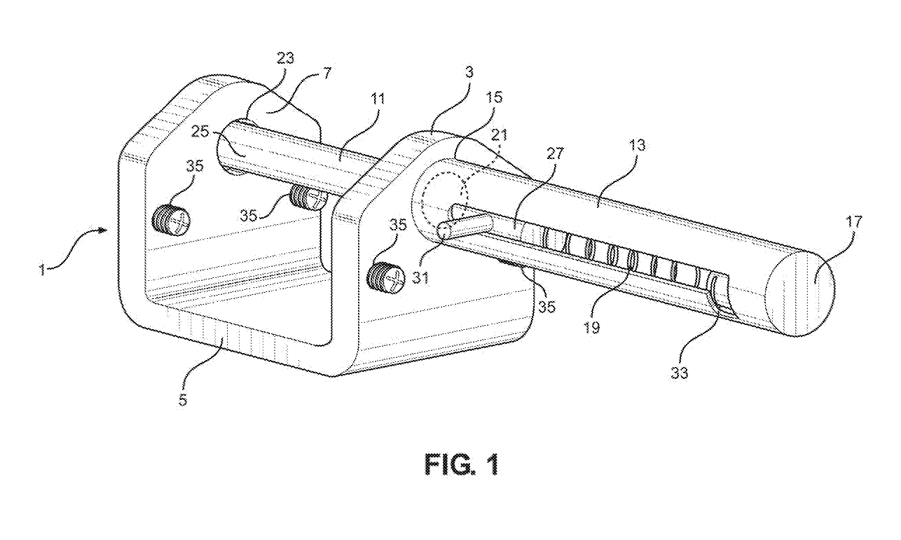

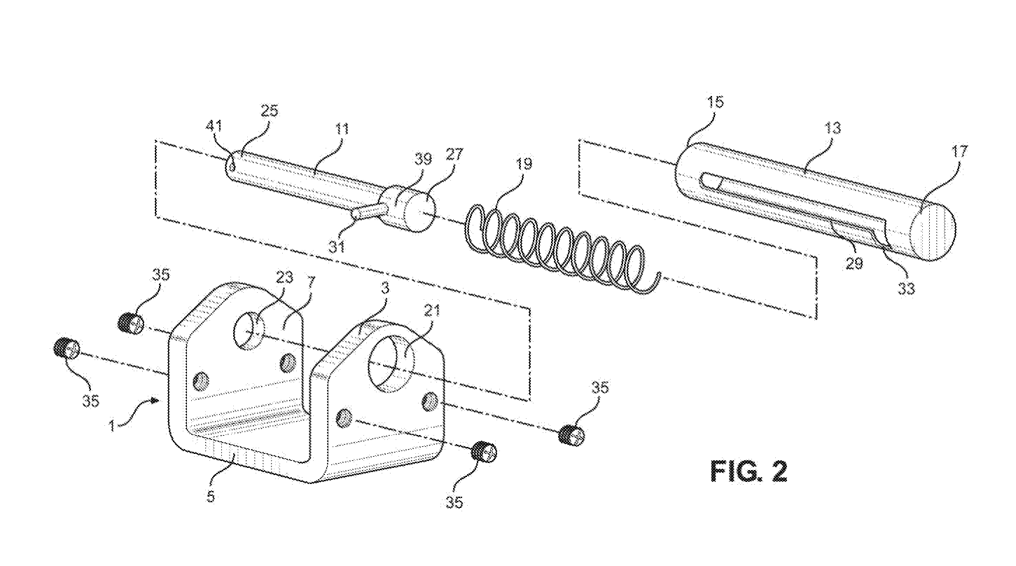

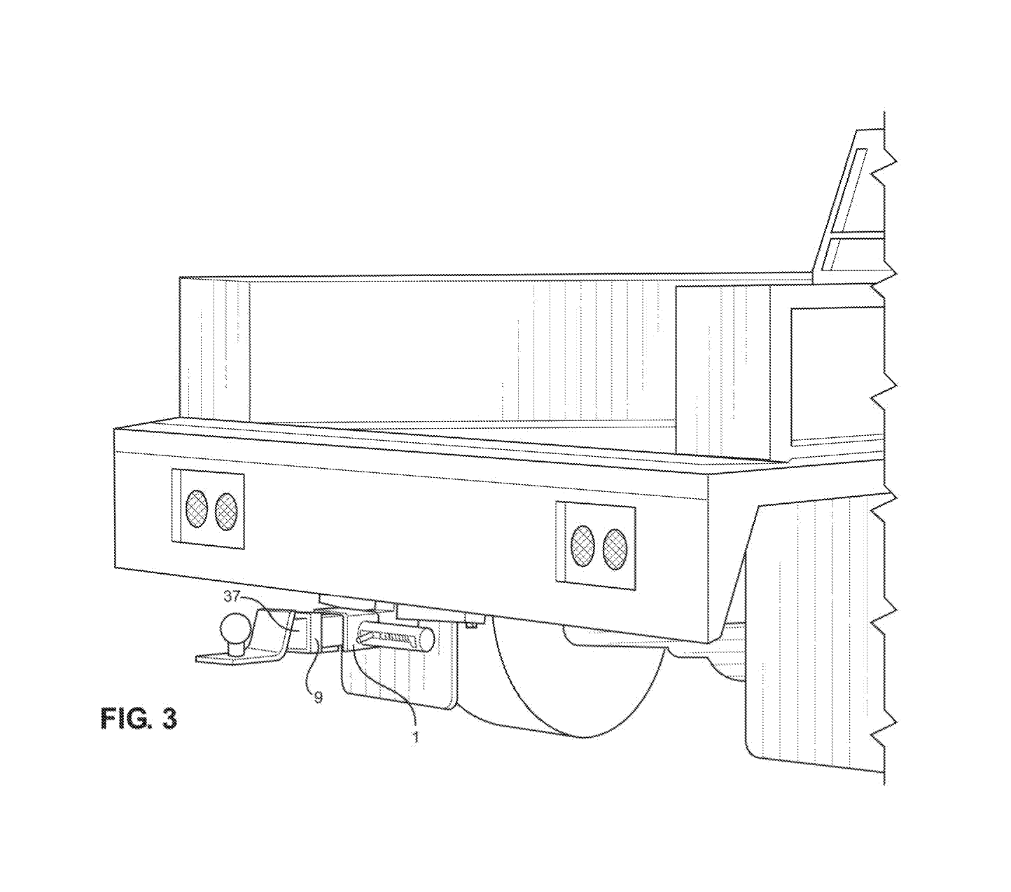

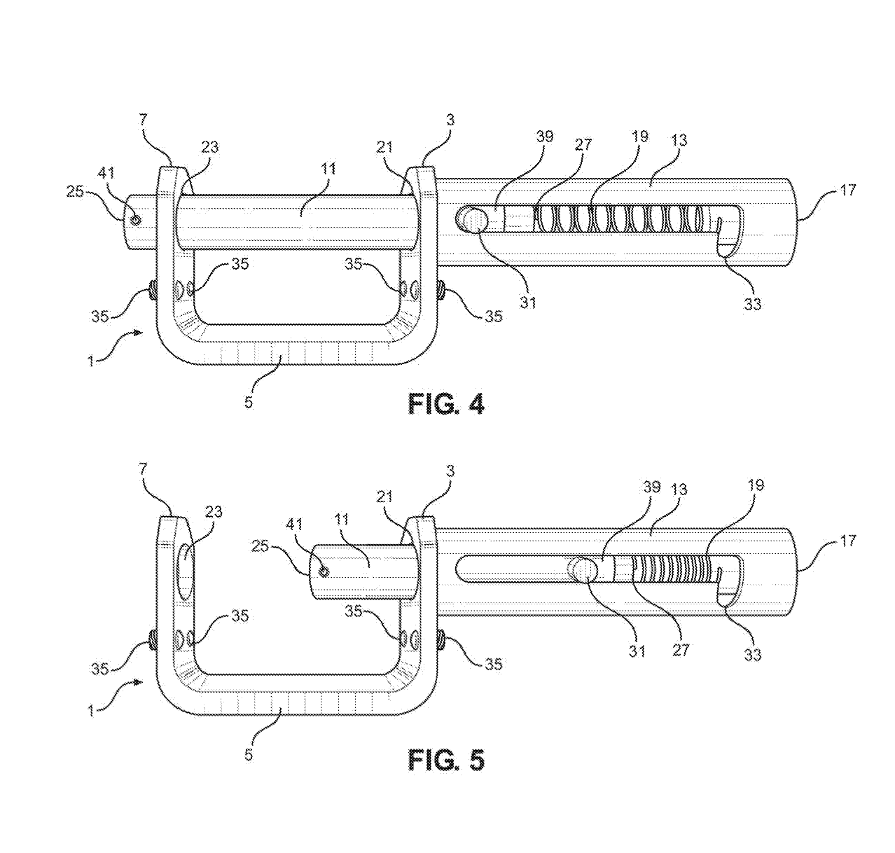

### DETAILED DESCRIPTION

Versions of the present invention are directed to a self-latching trailer hitch device. In a preferred embodiment, the device comprises a bracket (1) having a first side (3), a second side (5) extending from said first side (3), preferably substantially perpendicularly, and a third side (7) extending from said second side (5), preferably substantially perpendicularly and in the same general direction of extension as the first side (3). A bracket (1) according to the present invention is configured and sized so that the first, second, and third sides will surround a hitch receiver (9) and position a device pin (11) in the manner described below. A bracket (1) according to the present invention will have an internal width between an inner surface of the first side (1) and an opposing inner surface of the third side (7) comprising a channel. The second side (5) should be of a length sufficient to render that channel large enough to accommodate a hitch receiver (9) of desired class and size. In most embodiments, the channel defined by the inner surfaces of the first, second, and third sides will have a width between 1¼ inches for lower-class receivers and 3 inches for higher-class receivers. In a preferred embodiment, the first, second, and third sides are configured in roughly a C-shape, and the inner surfaces of those sides comprise a channel with a width of approximately 2½ inches.

The device of the present invention further comprises a housing (13) extending from an outer wall of said first side (3). The housing (13) extends generally in a direction opposite the direction of extension of the second side (5), such that the pin (11) housed within the housing (13) is positioned to bridge the first side (3) and third side (7) when the device is placed into a closed position as described below. The housing (13) has a proximal end (15) located at an interface or connection of the housing (13) with the outer wall of the first side (3), and a distal end (17) located opposite the proximal end (15). In a preferred embodiment, the housing is generally tubular in shape, although a variety of external shapes and dimensions could be employed within the scope and spirit of the invention. The housing (13) can be of any length sufficient to accommodate a pin (11) and a biasing member (19). The first side (3) comprises a first opening (21) in alignment with the housing (13). The first opening (21) is sized and shaped to permit portions of the pin (11) housed within the housing (13) to slidably pass through the first side (1). The third side (7) comprises a second opening (23) substantially in alignment with the first opening (21). The second opening (23) is sized and shaped to permit portion of the pin (11) housed within the housing (13) to slidably pass through at least a portion of the third side (7) after portions of the pin (11) have passed through the first side (1), such that the pin (11) bridges the first side (3) and the third side (7).

The housing (13) houses at least a pin (11) and a biasing member (19). The pin (11) comprises a pin nose (25) and a pin base (27) and is slidably retained inside of the housing (13). The pin (11) has a length equal to or greater than the distance between an outer wall of the first side (3) and an inner wall of the third side (7). In a preferred embodiment, the pin (11) has a length greater than the distance between the outer wall of the first side (3) and the outer wall of the third side (7), such that the pin nose (25) can extend beyond the outer wall of the third side (7) while the pin base (27) remains within the housing (13). While the pin (11) can be of virtually any material or diameter, preferred materials and diameters will correspond to pull pins commonly used in receiver-style hitches, including, variously, Class I, II, III, and IV rated hitches. In a preferred embodiment, the pin (11) is a load-resistant steel alloy with a diameter of approximately ⅝ inch. Suitable steels include, by way of example, 4140 steel and B80 stainless steel with 18-8 Rockwell hardness.

The biasing member (19) is also housed within the housing (13). The biasing member (19) biases and urges the pin (11) in the direction of the third side (7) so that if the pin (11) is permitted to travel freely, it will extend from the housing (13) through the first opening (21) and the second opening (23) to bridge the first side (3) and third side (7). As will be appreciated by one skilled in the art, the biasing member (19) can comprise a number of different mechanical, hydraulic, or pneumatic devices or systems configured to bias the pin (11) in a desired direction. Preferably, the biasing member (19) provides sufficient force to allow the pin (11) to snap into place during even a brief alignment of the first opening (21) and the second opening (23) with corresponding holes in a hitch receiver (9). In a preferred embodiment, the biasing member (19) is a zinc-plated music wire steel compression spring of 3.5 inches overall length, 0.71 inches compressed length, and 0.6 inches outside diameter, with a maximum load rating of 7.30 pounds and a rate of 2.70 pounds per inch. As will be apparent to one skilled in the art, a variety of lengths, diameters, maximum load, and rate parameters would be suitable for use within the device.

Embodiments of the device may further include a longitudinal slot (29) running along at least a portion of the longitude of the housing (13). In these embodiments, the longitudinal slot (29) through the housing (13) serves as an opening to provide access to the pin (11), to allow it to be manually repositioned. Preferably in these embodiments, the pin (11) is connected to a handle (31) with a handle body, where the handle (31) is connected to the pin (11) at one end, and extends away from the pin (11), with the handle body passing through the longitudinal slot (29). Thus, movement of the handle (31) will result in movement of the pin (11) longitudinally with respect to the housing (13). For example, by grasping the handle (31) and pulling the pin (11) toward the housing distal end (17) until the pin nose (25) is retracted, the device may be placed into an open position, as shown in FIG. 5. In the fully open position, the distance between the pin nose (25) and the inner surface of the third side (7) should be equal to or greater than the width of the hitch receiver (9) in connection with which the device is intended to be used. For example, for a device configured for use with a 2¼ inch hitch receiver (9), the distance between the pin nose (25) and the inner surface of the third side (7) should be at least 2¼ inches when the device is in its fully open position.

Embodiments of the device may further comprise a locking slot (33) substantially transverse or perpendicular to the longitudinal slot (29). The locking slot (33) intersects with the longitudinal slot (29) so that the handle (31) may be moved from the longitudinal slot (29) into the locking slot (33) at a specific pin position, permitting the pin (11) to be temporarily locked in that position despite the force applied by the biasing member (19). The locking slot (33) is preferably located toward the housing distal end (17), at a location where movement of the handle (31) along the longitudinal slot (29) to the locking slot (33), and then into the locking slot (33), will result in the device being locked into a fully open position as described above.

In preferred embodiments of the present invention, the pin (11) is configured so that while the pin (11) is slidably moveable within the housing (13), the pin base (27) is captive within the housing (13) and cannot be readily removed from the housing (13) solely by the exertion of linear force by the biasing member (19). The arrangement of the moveable, but partially captive pin (11) within the housing (13) can be achieved in a variety of ways that will be apparent to one skilled in the art. In a preferred embodiment, the pin (11) comprises a protrusion (39), preferably near the pin base (27), that renders the pin (11) at the point of the protrusion (39) too large to pass through the first opening (21). In this way, the device has a fully open position in which the pin (11) is maximally retracted into the housing (13), and a fully closed position in which the pin (11) is maximally extended from the housing (13) but still partially secured within the housing (13).

In preferred embodiments, the pin (11) is sufficiently long that when the device is in the fully closed position, the pin nose (25) is located at a position beyond the outer wall of the third side (7). In preferred embodiments, a locking means (41) is located on the pin (11) at a position selected to be beyond the outer wall of the third side (7) when the device is in the fully closed position. The locking means (41) is preferably near the pin nose (25). The locking means (41) can comprise a variety of mechanical arrangements configured to lock the pin (11) substantially in the fully closed position. In one embodiment, the locking means (41) may be a circumferential ring scribed into the pin (11) configured to accept a friction fit collar, the collar being of sufficient width to prevent passage through the second opening (23). Alternately, the locking means (41) may be a second locking slot on the housing (13) located near the housing proximal end (15). In another embodiment, the locking means (41) may comprise a threaded pin nose (25) that can, when the device is in the fully closed position, be fitted with a nut to prevent passage through the second opening (23). In a preferred embodiment, the locking means (41) is an aperture located transversely through the pin (11), configured to accept a cotter pin.

Embodiments of the present invention may further comprise secondary attaching members (35) configured to temporarily hold the device in place when the device is in use, particularly when the pin (11) is in the fully open position. A number of mechanical structures such as screws, clips, clamps, adjustable collars, and cords, are suitable for use as secondary attaching members (35). In a preferred embodiment, the secondary attaching members (35) comprise a plurality of set screws within the first side (3) and third side (7) configured to hold the device in place on a receiver hitch (9) when the pin (11) is in the fully open position.

In use, embodiments of the present invention function generally in the following manner: a trailer to be towed has a tongue jack attached to its tongue and coupler and used to raise or lower the coupler. The tongue jack is used to raise the coupler to a height high enough to clear the top of a ball mount comprising a ball and a ball mount shaft (37). The ball mount, with an appropriately-sized ball installed, is mated to a hitch receiver (9) of a particular size and class by sliding the ball mount shaft (37) into the hitch receiver (9), but is not locked into place with a pull pin. An appropriately-sized embodiment of the device is then used in connection with the hitch receiver (9). In a preferred embodiment, the device is locked into an open position by moving the handle (31) towards the housing distal end (17) to retract the pin (11) into a fully open position, and then moving the handle (31) into the locking slot (33) to lock the pin (11) into a fully open position. The bracket (1) is then placed around the hitch receiver (9) so that the first opening (21) and second opening (23) are aligned with corresponding openings in sidewalls of the hitch receiver (9). The device may be secured in this position using any number of secondary attaching members (35), such as set screws. The ball mount shaft (37) is moved within the hitch receiver (9) until openings in sidewalls of the ball mount shaft (37) corresponding to the openings in the sidewalls of the hitch receiver (9) are out of alignment with the hitch receiver (9) openings. The handle (31) is then moved out of the locking slot (33), allowing the biasing member (19) to urge the pin (11) toward a closed position. Due to the misalignment of the openings in the ball mount shaft (37) with the openings of the hitch receiver (9), a portion of the pin (11) will pass through the first side (3) and through one opening in the sidewall of the hitch receiver (9), but will be stopped from further progress towards a fully closed position by contact of the pin nose (25) with a solid portion of the sidewall of the ball mount shaft (37). The tow vehicle is then backed carefully toward the trailer until the ball is located in the vicinity of the coupler. The ball may then be moved to the coupler by a combination of making small adjustments to the location of the coupler and moving the ball mount shaft (37) longitudinally in and out within the hitch receiver (9). After the ball and coupler are aligned, the tongue jack is used to lower the opened coupler onto the ball. After the ball is firmly seated within the coupler, the coupler is latched into the closed position and locked closed. The tow vehicle can then be moved forward or backward to align the sidewall openings of the ball mount shaft (37) with the corresponding openings of the hitch receiver (9). At the moment of sufficient alignment of the sidewall openings of the hitch receiver (9) and the ball mount shaft (37), the biasing member (19) will force the pin (11) into a fully closed position by causing the pin nose (25) to pass through the near sidewall opening in the ball mount shaft (37), the far sidewall opening in the ball mount shaft (37), the far sidewall opening in the hitch receiver (9), and the second opening (23), securing the ball mount shaft (37) to the hitch receiver (9) with substantially similar or greater structural integrity than a traditional pull pin. A locking means (41) may optionally be used to secure the pin (11) into a fully closed position. At this time, supplemental or safety equipment such as weight distribution spring bars, safety chains, or electrical connections may be connected.

Although the present invention has been described in considerable detail with reference to certain preferred versions thereof, other versions are possible. Therefore, the spirit and scope of the claims should not be limited to the description of the preferred versions described herein.

What is claimed is:

1. A self-latching hitch device comprising:
a bracket having a first side, a second side extending from said first side, and a third side opposite said first side and extending from said second side;
a housing having a proximal end terminating in said first side and a distal end opposite said proximal end, wherein said housing extends from said first side in a direction opposite the direction of extension of said second side;
a pin slidably retained inside of said housing with a length equal to or greater than the distance between said first side and said third side;
a biasing member housed inside said housing, said biasing member configured to bias said pin in the direction of said third side;
wherein said first side comprises a first opening sized to allow at least a portion of said pin to slide through said first opening, and said third side comprises a second opening aligned with said first opening and sized to allow at least a portion of said pin to slide through said second opening; and
wherein said device has an open position in which said pin is substantially contained within said housing, and a closed position in which said pin is substantially biased out of said housing such that a portion of said pin is passed through said second opening.

2. The self-latching hitch device of claim 1, wherein said biasing member comprises at least one of a spring, a hydraulic pressure system, and an air pressure system.

3. The self-latching hitch device of claim 1, wherein said pin comprises a base contacting said biasing member and a nose, and wherein said pin further comprises a protrusion sized to prevent said base from exiting said first opening.

4. The self-latching hitch device of claim 3, wherein said pin further comprises a locking means, and wherein when said device is in the fully closed position, said locking means is located at a position beyond said third side opposite said first side.

5. The self-latching hitch device of claim 1, wherein said housing further comprises a longitudinal slot.

6. The self-latching hitch device of claim 5, further comprising a handle connected to said pin, wherein said handle slides along said longitudinal slot when said device is in use.

7. The self-latching hitch device of claim 6, wherein said housing further comprises a locking slot approximately perpendicular to and connecting to said longitudinal slot at the end of said longitudinal slot closest to said housing distal end.

8. The self-latching hitch device of claim 7, wherein said pin can be locked into said open position by sliding said handle into said locking slot.

9. The self-latching hitch device of claim 1, further comprising at least one secondary attaching member configured to hold said device in place on a receiver hitch while said device is in use.
